(19) United States
(12) Patent Application Publication
(10) Pub. No.: US 2014/0141890 A1
(43) Pub. Date: May 22, 2014

(54) AMUSEMENT SYSTEM

(71) Applicants: Yoshitaka Nishimura, Minato-ku (JP); Kazuha Hayashi, Minato-ku (JP); Takayuki Ishikawa, Minato-ku (JP)

(72) Inventors: Yoshitaka Nishimura, Minato-ku (JP); Kazuha Hayashi, Minato-ku (JP); Takayuki Ishikawa, Minato-ku (JP)

(73) Assignee: KONAMI DIGITAL ENTERTAINMENT CO., LTD., Minato-ku (JP)

(21) Appl. No.: 14/130,768

(22) PCT Filed: Jul. 12, 2012
(86) PCT No.: PCT/JP2012/067858

§ 371 Date: Jan. 3, 2014

(30) Foreign Application Priority Data
Jul. 19, 2011 (JP) 2011-158457

(51) Int. Cl. A63F 13/30

(52) U.S. Cl. CPC A63F 13/12
USPC 463/42

(57) ABSTRACT

This amusement system is provided with: a server storage unit (10) that stores contents (11) submitted over a network (5); a contribution site server (3) that provides a contribution site (13) that receives contribution of contents (11) and utilization of contents (11) over the network (5); and a service provision site server (4) that provides a service provision site (17) that provides, over the network (5), a service associated with a game to a user while managing association with his user ID. The service provision site (17) is provided with a content replay region (SR) that is linked to the contribution site (13) in such a manner that contents (11) can be used, and a ranking information page (RP) that provides information that ranks contents (11) in accordance with its state of use on the contribution site (13).

### TECHNICAL FIELD

The present invention relates to an amusement system that employs a network.

### BACKGROUND ART

A music game is known that, along with displaying notebars corresponding to rhythm sound along a predetermined path, also guides timing of operations by making the notebars shift facing a reference line which corresponds to the present time instant, so that these notebars reach at the reference line (for example, refer to Patent Document #1).
Patent Literature: Patent Document #1: Japanese Laid-Open Patent Publication 2001 96061.

### SUMMARY OF INVENTION

### Technical Problem

With the game apparatus of Patent Document #1, contents of music are employed, and the player is requested to perform operations matched to the music. Due to this, the quality of the contents utilized in the game exerts an influence upon the level of interest of the game. In other words, if the quality of the contents utilized in the game is not good, then the player's interest in the game is undesirably diminished. Moreover, there is also an undesirable possibility that a bias may occur in the contents to be used according to the supplier of the game. Furthermore, there is further an undesirable possibility that a considerable time and cost are required for development including processes such as processes for selecting and creating such contents.

Accordingly, the object of the present invention is to provide an amusement system that can evaluate contents to be used in amusement via a network in advance.

### Solution to Problem

The amusement system of the present invention includes: a content storage unit that stores a content which is associated with an amusement supplied to a user, and is submitted via a network; a contribution site provision server that provides a contribution site that receives, via the network, submission of the content and utilization of the content stored by the content storage unit; and a service site provision server that provides a service provision site that provides a service associated with the amusement to a user, via the network, while managing association with information required for specifying the user; wherein a link unit that links to the contribution site so that the content is used, and a ranking information provision unit that provides ranking information for the content in accordance with a state of use on the contribution site, are provided in the service provision site.

According to the present invention, a content that have been submitted via the contribution site is assigned rankings by the user of the contribution site. Due to this, via the ranking assignments, it is possible to receive a wide range of evaluations by user of the service provision site. In other words, it is possible to evaluate in advance content for which there is a possibility of utilization in the amusement, via the network. Moreover, since the service associated with the game is provided by the service provision site, accordingly the user is someone who has an interest in the game. In other words, the reliability of the evaluations is high. Due to this, it is possible to anticipate a guarantee of the quality of the content. Moreover, since there is a possibility that content that has been evaluated on the service provision site will actually be employed in the amusement, accordingly the user of this site can be incentivized to use the amusement. Due to this, it is possible to guide the user of the service provision site towards utilization of the amusement. And the supplier of the amusement need not prepare the content, since the content is submitted via the contribution site. In other words, it is possible to shorten the time period required for development of the content, and so on. Incidentally, it should be understood that utilization of the content means at least reviewing and replaying of the content.

In one aspect of the amusement system of the present invention, the contribution site may be adapted and configured to provide receipt of at least one of the submission of the content and the utilization of the content while managing association with information required for specifying a user; and the information for specifying the user of the contribution site and the information for specifying the user of the service provision site may be managed as mutually different sets of information. In this case, the user of the contribution site is managed separately from a user of the service provision site. Accordingly, it is possible for the management and the administrator of the contribution site to be different from the management and the administrator of the service provision site. Due to this, a person who is capable of specializing in submission and utilization of a content can handle supply of the contribution site, and a person who is capable of specializing in supply of a service in connection with games can handle supply of the service provision site. And, because of this, along with it being possible to enhance the functionality of both of the sites, also it is possible to lighten the burden of management administration. Furthermore, along with it being possible to guide the user of the two sites to them mutually, it is also possible to incentivize utilization of the amusement by users of both the sites. Due to this, along with it being possible further to enhance the quality of the evaluations, also it is possible to guide a larger number of users towards the amusement.

And, in one aspect of the amusement system of the present invention, there may be further included an association data storage unit that stores association data that is used for making association between the content and the user of the service provision site; and wherein the link unit may be adapted and configured to link to the content which is associated with the user of the service provision site by the association data. In this case it is possible to perform assignment of rankings to the content in a more effective manner, since it is possible to restrict the content that is the subject of ranking. Accordingly, if for example association data is prepared that includes only a content that have been applied to the amusement, then it is possible to restrict the content in an effective manner.

And, in one aspect of the amusement system of the present invention, a relationship specification unit that is employed for specifying a correspondence relationship between the user of the service provision site and the content may be provided to the service provision site. In this case, it is possible to make the user set up correspondence between the content and the user by utilizing this relationship specification unit. Due to this, it is possible to trust the user with the decision as to whether or not the content is adequate for the amusement. And, because of this, for example by publishing information or the like about the content that has been adequate for the amusement, it is possible to restrict the content of the subject on the basis of decisions by the user.

And, in one aspect of the amusement system of the present invention, a voting unit that receives votes for the content may be provided to the service provision site, and the number of votes via the voting unit may be reflected in the ranking information. In this case, it is possible to take the opinions of the user directly into account in evaluations.

Moreover, in aspects of the voting unit that is provided, the voting unit is also provided to the contribution site; or the voting unit may be provided to the link unit. In these cases, it is possible to reflect direct opinions from the two sites mutually in evaluations.

Moreover, in an aspect to which the voting unit is provided, a voting history unit that provides information about the voting history with the voting unit to the user may be provided to the service provision site. In this case, it is possible to mutually confirm the evaluations by the user. By confirming evaluations between different users in this manner, for example, it is possible to encourage voting, and to encourage utilization of the content.

And, in one aspect of the amusement system of the present invention, a link to the service provision site may be provided in the contribution site. In this case, it is possible for users of both these sites to guide one another.

And, in one aspect of the amusement system of the present invention, there may be further provided an editing unit adapted and configured to perform editing so as to use at the amusement, the content to which a ranking has been assigned by the ranking information provision unit. In this case, it is possible to employ the content that has been evaluated to the amusement, in a simpler and easier manner.

The content of the rankings may also be employed in some type of amusement. For example, in one aspect of the amusement system of the present invention, there may be further provided a gaming machine that provides a predetermined game as the amusement, and wherein the content to which a ranking has been assigned by the ranking information provision unit may be employed in the predetermined game.

### Advantageous Effects of Invention

As has been explained above, according to the present invention, a content submitted via the contribution site is assigned rankings by the user of the service provision site. By doing this, via the rankings, it is possible to receive evaluations from the user of the service provision site over a wide range. In other words, it is possible to evaluate the content to be utilized by the amusement in advance via the network.

### BRIEF DESCRIPTION OF DRAWINGS

FIG. 1 is a figure showing a summary of the overall structure of an amusement system according to an embodiment of the present invention;

FIG. 2 is a functional block diagram of this amusement system;

FIG. 3 is a figure showing an outline of a business flow;

FIG. 4 is a figure showing sharing out of the roles of a contribution site and a service provision site;

FIG. 5 is a figure showing an example of a contribution page;

FIG. 6 is a figure showing an example of a review and replay page;

FIG. 7 is a figure showing an example of a ranking information page;

FIG. 8 is a figure showing an example of details of contents management data; and

FIG. 9 is a figure showing an example of details of subscription data.

### DESCRIPTION OF EMBODIMENTS

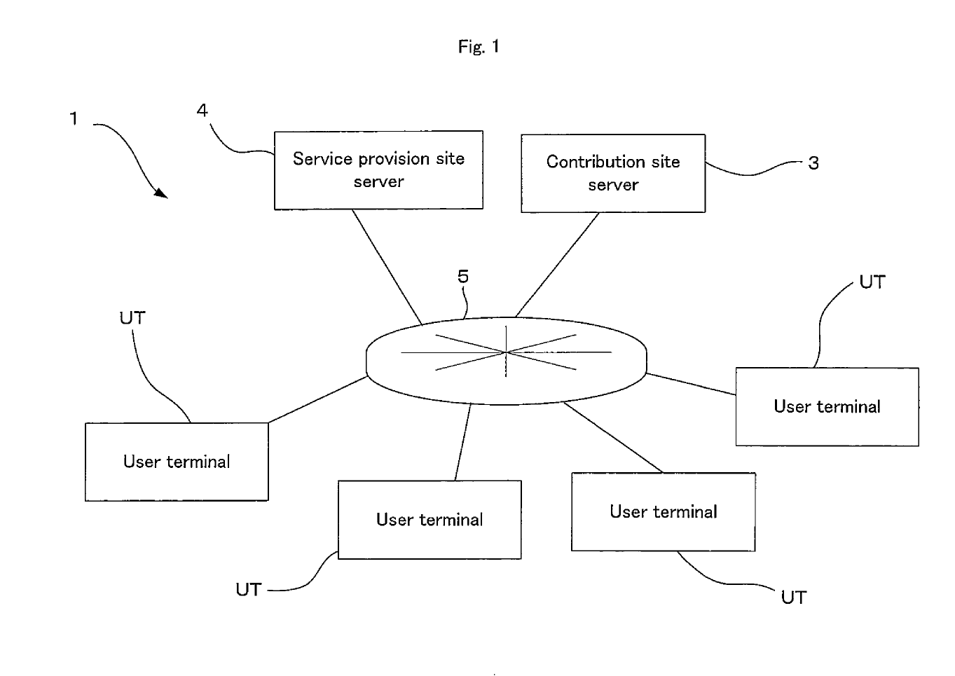

In the following, an embodiment of an amusement system according to the present invention will be explained. FIG. 1 is a figure showing a summary of the overall structure of this amusement system according to an embodiment of the present invention. As shown in FIG. 1, in this amusement system 1, a server 3 for providing a contribution site, a server 4 for providing a service provision site, and a plurality of user terminals UT are connected together via a network such as the internet or the like so as to be capable of mutual communication.

Incidentally, it should be understood that the contribution site server 3 and the service provision site server 4 are not limited to an example in which they all consist of individual single physical devices; a single logical contribution site server 3 or a single logical service provision site server 4 may be embodied as a server group that consists of a plurality of physical devices. Moreover, as one example of one of user terminals UT, a personal computer that is equipped with a network connection function may be employed, but alternatively it would also be possible to employ a mobile telephone or the like. Furthermore, either a cable network or a wireless network (including the mobile telephone network) may be employed as the network.

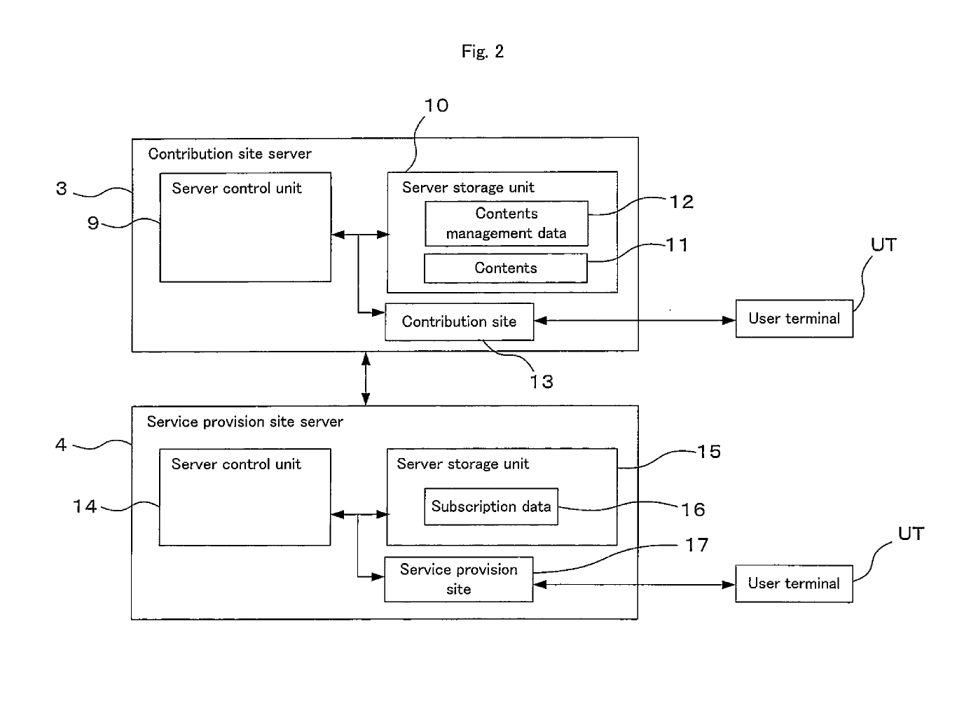

FIG. 2 is a functional block diagram of this amusement system 1. As shown in FIG. 2, the amusement system 1 comprises the contribution site server 3 and the service provision site server 4. A server control unit 9 and a server storage unit 10 are provided to the contribution site server 3. The server control unit 9 is built as a combination of a microprocessor and peripheral devices of various types that are required for the operation of this microprocessor, such as internal storage devices (for example ROM and RAM) and so on.

The server storage unit 10 is configured by, for example, a hard disk, a flash SSD (Solid State Drive), or the like so as to be capable of maintaining storage even when not being supplied with power. Contents 11 and contents management data 12 are stored in the server storage unit 10. Data of various types is included in the contents 11, such as audio data, image data, music data, video data, and so on. Moreover, contents uploaded from the user terminals UT to the contribution site server 3 via the network 5 are included in the contents 11. A unique contents ID is appended to each item of contents in the contents 11. This contents ID is used for identifying each item of contents 11. By storing the contents 11, the server storage unit 10 functions as the “content storage unit” of the Claims.

The contents management data 12 is data for managing the contents 11. This contents management data 12 is referred to as appropriate by the server control unit 9 according to requirements, and also is updated. The details of the contents management data 12 will be described hereinafter. Incidentally, it should be understood that although, apart from the above, programs and data of various types referred to by the server control unit 9 are also stored in the server storage unit 10, these are not shown in the figures.

A contribution site 13 is constructed in the contribution site server 3 on the basis of programs and data of various types (not shown in the figures) stored in the server storage unit 10. Management and control and so on of this contribution site 13 is performed by the server control unit 9. The contribution site 13 is a site that receives contributions and reviews and requests for replaying of contents 11 such as videos and so on. The contribution site 13 is supplied via the network 5, and each user terminal UT can access the contribution site 13. A log-in ID is required for accessing the contribution site 13. This log-in ID is information required for specifying the user of the contribution site 13. Contents 11 contributed to the contribution site 13 are stored in the server storage unit 10. Moreover, via the contribution site 13, a user can read and replay contents 11 stored in the server storage unit 10.

On the other hand, a server control unit 14 and a server storage unit 15 are provided to the service provision site server 4. The server control unit 14 is built as a combination of a microprocessor and peripheral devices of various types that are required for the operation of this microprocessor, such as internal storage devices (for example ROM and RAM) and so on.

The server storage unit 15 is configured by, for example, a hard disk, a flash SSD (Solid State Drive), or the like so as to be capable of maintaining storage even when not being supplied with power. Subscription data 16 serving as association data is stored in the server storage unit 15. Subscription data 16 is data for managing subscribers with respect to predetermined contributions. This subscription data 16 is referred to as appropriate by the server control unit 14 according to requirements, and also is updated. The details of the subscription data 16 will be described hereinafter. Incidentally, it should be understood that although, apart from the above, programs and data of various types referred to by the server control unit 14 are also stored in the server storage unit 15, these are not shown in the figures. Moreover, by storing the subscription data 16, the server storage unit 15 functions as the “association data storage unit” of the Claims.

On the basis of programs and data of various types (not shown in the figures) stored in the server storage unit 15, a service provision site 17 is constructed in the service provision site server 4. Management and control and so on of the service provision site 17 are performed by the server control unit 14. The service provision site 17 is a site that provides predetermined services associated with games. The service provision site 17 is supplied via the network 5, and the user terminals UT can access the service provision site 17 via the network 5. A user ID is required for accessing the service provision site 17. This user ID is information required for specifying the user of the service provision site 17. In other words, the service provision site 17 is a site that supplies predetermined services, while taking advantage of the user ID for specifying the user.

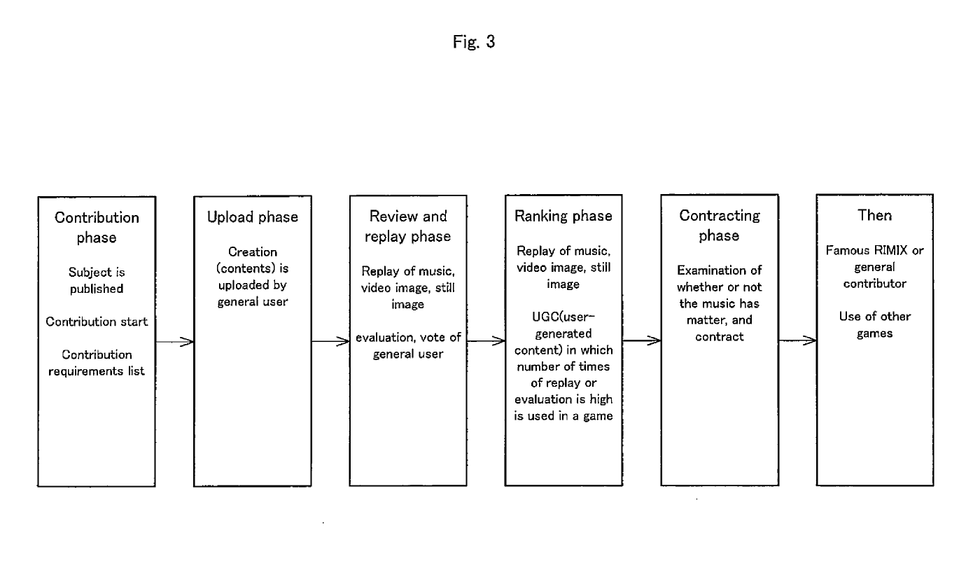

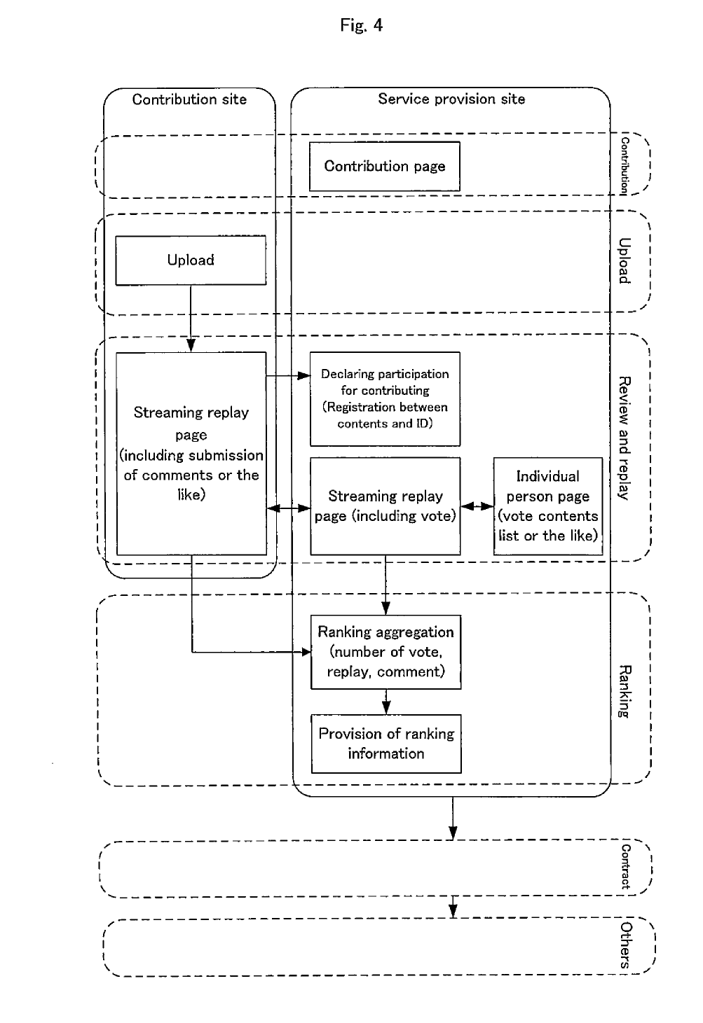

Next, a business flow that makes use of this amusement system 1 will be explained with reference to FIGS. 3 and 4. FIG. 3 is a figure showing an outline of this business flow. As shown in FIG. 3, first, in a contribution phase, contents 11 are contributed according to a contribution requirements list or the like. As such contents 11, for example, an item of music, a video image, a still image or the like may be contributed. Next, in an upload phase, the user uploads the contents 11 to the server via the network 5. And next, in a review and replay phase, the contents 11 uploaded by each user are reviewed and replayed via the site provided by the server. Moreover, the contents 11 that are reviewed and replayed are evaluated by the users who have reviewed them and so on via voting or the like. And, in a ranking phase, a ranking for each item of contents 11 is created according to the results of these evaluations. In concrete terms, the rankings are created on the basis of the number of times the contents have been replayed, or upon the number of votes they have received. Moreover, via predetermined examination and conclusion of a contract in a contracting phase, an item of contents having a higher ranking, for example an item of music or the like, may be employed in a music game in an amusement facility or the like as an item of music during the game. Yet further, if such an item of contents is used in a music game or the like and its evaluation is high, then its use is also promoted in other games and so on.

The business flow of FIG. 3 is actualized via the contribution site 13 and the service provision site 17. FIG. 4 is a figure showing the way in which the roles of these sites are allocated. As shown in FIG. 4, the contribution phase, the upload phase, the review and replay phase, and the ranking phase are executed via the contribution site 13 and the service provision site 17.

The contribution site 13 handles the upload phase and a portion of the review and replay phase. In concrete terms, a page is provided in the contribution site 13 for submitting contents 11, in other words for receiving uploads. Moreover, a streaming replay page is also provided in the contribution site 13 for reviewing contents 11 that have been uploaded. This streaming replay page is adapted for it to be possible to submit comments from the user terminals, in other words for it to be possible to add comments to the contents 11. Incidentally, in this streaming replay page, there may be provided links to a subscription page and to a streaming replay page of the service provision site 17. This subscription page and streaming replay page will be described hereinafter.

On the other hand, the service provision site 17 handles the contribution phase, a portion of the review and replay phase, and the ranking phase. In concrete terms, at an appropriate timing along with the start of a contribution, a contribution page is provided in the service provision site 17 including information such as a contribution requirements list and so on. For example, in this contribution requirements list, there are included types of contents 11 that can become subjects of contribution, such as music (audio data), a jacket (image data), music score data for implementing music, or video data.

Furthermore, a subscription page is provided in the service provision site 17 for declaring participation for contributing at an appropriate timing along with starting a contribution, in other words for subscription. This subscription page is set up so as to be able to make a linked registration between contents 11 on the contribution site 11 and a user ID on the service provision site 17. For example, this linked registration may be implemented by linking to the contribution site 13, by specifying contents 11 via selection by the user, and by adding (or being inputted by the user) a user ID during access to the specified contents 11. Or alternatively, for example, it would also be possible for the linked registration to be implemented by the contents ID or URL being inputted directly. Due to the provision of this type of structure, the subscription page functions as the “relationship specification unit” of the Claims.

Moreover, a streaming replay page on which contents 11 that have been subscribed for can be reviewed is provided in the service provision site 17. This streaming replay page is built so as to link to the streaming replay page of the contribution site 13. In other words, on the streaming replay page of the service provision site 17, the contents 11 are reviewed via the streaming replay page of the contribution site 13. Moreover, this streaming replay page is built so that the user is enabled to vote upon the contents 11 on the contribution site 13. In other words, it is made possible for the contents 11 of the contribution site 13 to be evaluated by the users of the service provision site 17. Incidentally, it should be understood that it would also be possible to build the streaming replay page of the contribution site 13 so that it can link to the streaming replay page of the service provision site 17, and the streaming replay page may be configured so as to be capable of voting upon the contents 11 (i.e. evaluation thereof) even when it is reviewed on contribution site 13.

The streaming replay page of the service provision site 17 is built so as to be capable of linking to pages for individual persons. An individual person page is provided for each user ID on the service provision site 17. In each individual person page, there is included Information such as the list of contents 11 for which the owner of this user ID has voted (i.e. his history), and the number of votes and the ranking order of each of those contents 11. Moreover, a link is also provided on the individual person page so that it is possible to link from the individual person page to the streaming replay page. This type of individual person page functions as the “voting history unit” of the Claims.

The number of replays that have been replayed (reviewed) on the streaming replay pages (those on both the sites 13 and 17), the number of votes, and the number of comments are aggregated by the server control units 9 and 14. The results of this aggregation are accessible at any time via the contribution site 13 and the service provision site 17. Moreover, rankings are created by the service provision site 17 on the basis of these aggregated results. Information about the rankings that have thus been created is supplied via a ranking information page that is provided upon the service provision site 17. This ranking information page functions as the “ranking information provision unit” of the Claims.

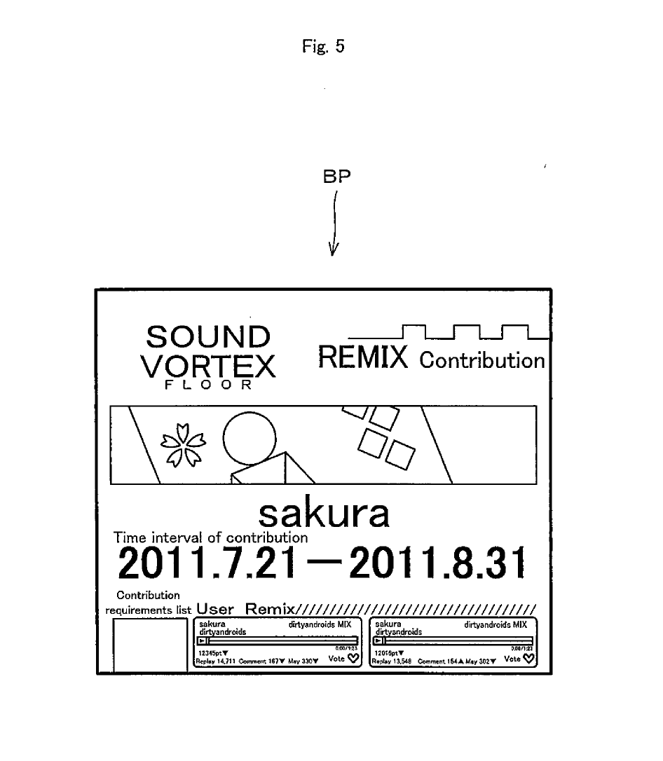

Next, certain pages on the service provision site 17 will be explained with reference to FIGS. 5 through 7. FIG. 5 is a figure showing an example of a contribution page. As shown in FIG. 5, on this contribution page BP, there is displayed information such as type of contents required, content of contents, time interval of contribution, a contribution requirements list. In the FIG. 5 example, audio contents is used as the type of contents required, and the contents in which music of “sakura” is remixed are required.

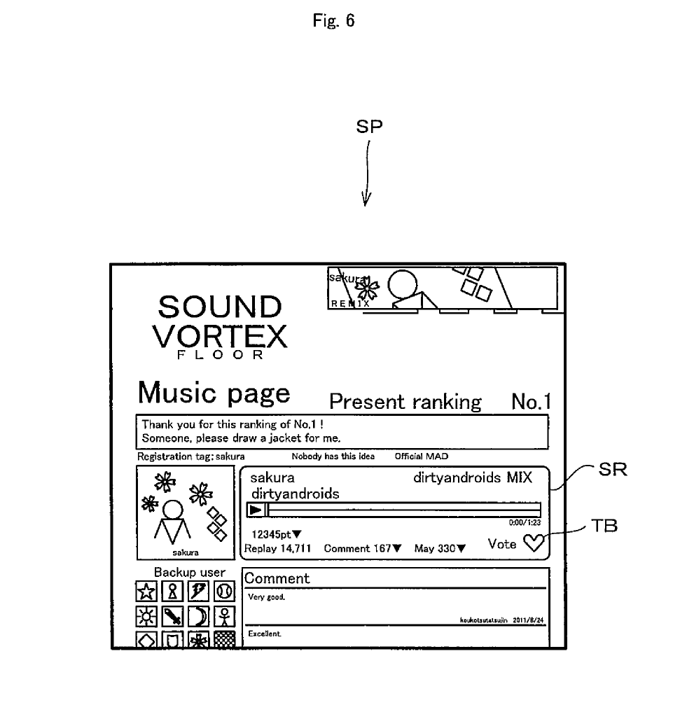

FIG. 6 is a figure showing an example of a review and replay page. As shown in FIG. 6, a contents replay region SR is provided on the review and replay page SP as a link portion. This contents replay region SR is directly linked to the contents 11 submitted to the contribution site 13. In other words, contents 11 that have been contributed to the contribution site 13 is directly reviewed and replayed via the contents replay region SR on this review and replay page. The number of replays are counted via the server control unit 9, and are totalized. Incidentally, it should be understood that, apart from the above, for example, information such as the number of replays, the number of comments that have been submitted, and the total points (points for ranking), may be included in the contents replay region SR.

Furthermore, a voting button TB serving as a voting section is provided on the review and replay page SP. Voting is performed when this voting button TB is selected. Votes are counted by the server control unit 14, and are added to the number of votes for the contents 11 that is the subject. The total number of votes added together is utilized by other pages, and is also reflected upon other pages. The voting button TB could also be provided in the contents replay region SR. Moreover, it would also be possible to provide a voting button TB on the contribution site 13 as well, for voting for contents 11 that have been subscribed. The example of FIG. 6 shows a case in which a voting button TB is also provided on the contribution site 13 corresponding to subscriptions. Incidentally, it should be understood that, apart from the above, on the review and replay page SP, there is also included information such as information and comments by the person who made the contribution, icons specifying supporters (i.e. voters) and their comments, and the current ranking order.

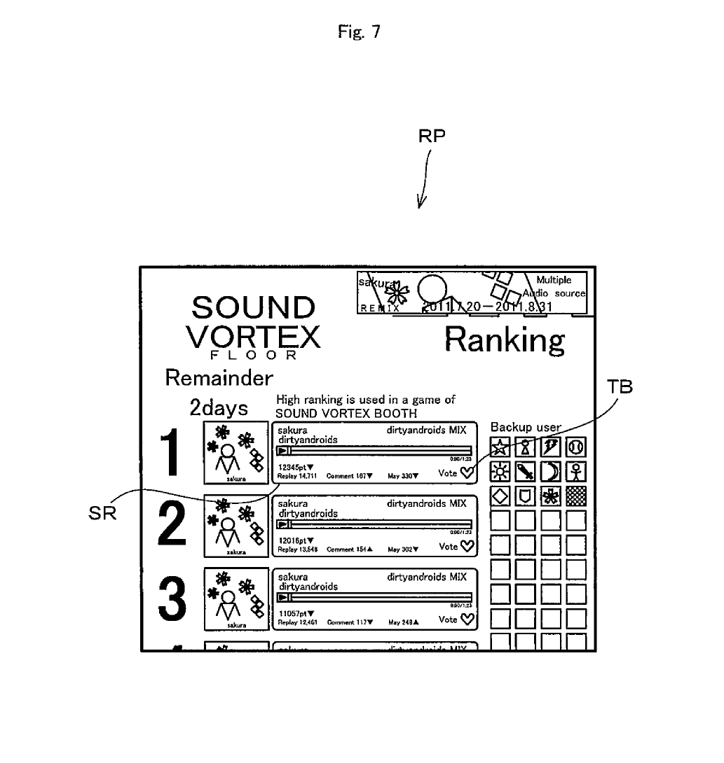

FIG. 7 is a figure showing an example of a ranking information page. As shown in FIG. 7, various contents 11 that have been subscribed to are displayed in order of ranking upon this ranking information page RP. Moreover, in the example of FIG. 7, a contents replay region SR and a voting button TB are also provided upon the ranking information page RP, and the ranking information page RP is adapted so as to be able to replay and vote of contents 11. Furthermore, apart from the above, various other types of information are included upon the ranking information page RP, such as the time remaining until the subscription expires, prizes (use for the game) to contents that have higher ranking, supporters, and so on.

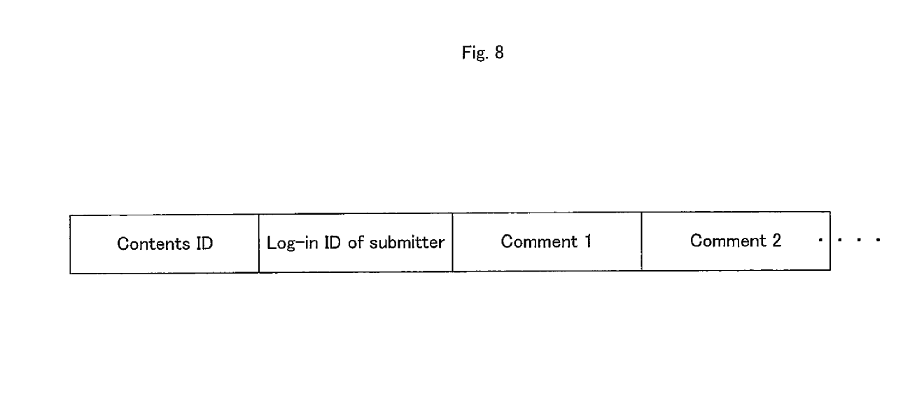

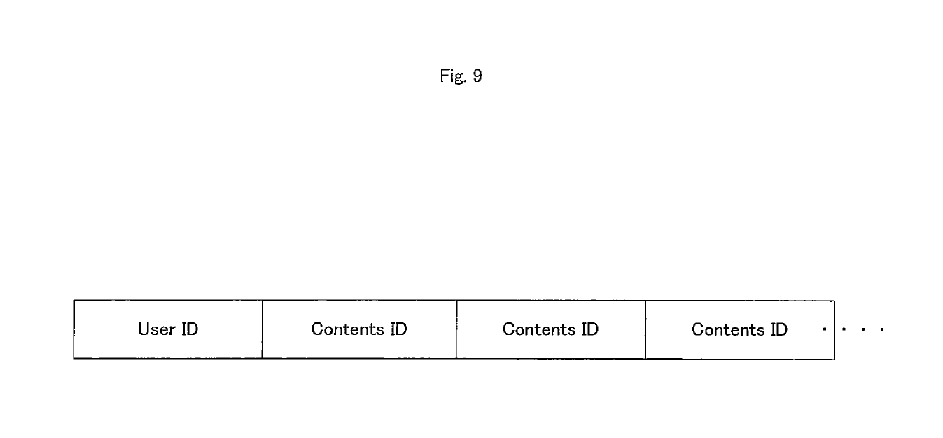

Next, the details of the contents management data 12 and the subscription data 16 will be explained with reference to FIGS. 8 and 9. FIG. 8 is a figure showing an example of the details of the contents management data 12. As shown in FIG. 8, groups of information items such as a contents ID corresponding to contents 11, the log-in ID of the person who submitted the contents 11, and comments appended to the contents 11 are included in the contents management data 12. The contents management data 12 is built as a set of a plurality of records corresponding mutually to these groups of information items. Updating and so on is performed upon the contents management data 12 by the server control unit 9, while referring to contents 11 and comments and so on that are submitted via the contribution site 13. Incidentally, it should be understood that, since a plurality of comments may be appended as information to a single item of contents, accordingly a plurality of items of comments information may correspond to a single contents ID.

On the other hand, FIG. 9 is a figure showing an example of the details of the subscription data 16. As shown in FIG. 9, groups of information items such as a user ID and contents ID are included in the subscription data 16. The subscription data 16 is built as a set of a plurality of records corresponding mutually to such groups of information items. Updating and so on is performed upon the subscription data 16 by the server control unit 14, while referring to contents registered via the service provision site 17. Incidentally, it should be understood that, since a plurality of contents may be subscribed for by a single user, in other words by one user ID, accordingly a plurality of contents IDs may correspond to a single user ID.

As has been explained above, according to this embodiment, via the network 5 such as the internet or the like, contents 11 to be utilized in a game such as a music game or the like can be widely contributed from typical users who utilize the service provision site 17. Due to this, it is possible to economize upon the development cost, the development time, and so on, required for the contents 11 to be prepared and so on.

Moreover, via the service provision site 17, rankings are attached to contents 11 submitted to the contribution site 13. Accordingly, via the network 5, it is possible to evaluate in advance contents 11 for which there is a possibility that they may be utilized in a game or the like, before utilizing them. Since the service provision site 17 is utilized by users who are interested in amusements such as games and so on, accordingly the reliability of their evaluations is high. Due to this, it is possible to be confident of the quality of contents 11 to be utilized in a game or the like by employing evaluations obtained via the service provision site 17.

Contents 11 that have received high evaluations are actually used in games. Due to this, along with enhancing the user's motivation to submit contents 11 and to subscribe, it is also possible to incentivize him/her to use games in which contents 11 that have been the subject of his evaluation are utilized. In this manner, by causing the user of the service provision site 17 to participate in part of the manufacture of a game, it is also possible to encourage the user of the service provision site 17 to use the game.

Furthermore, since mutually different user IDs are employed by the contribution site 13 and the service provision site 17, accordingly it is possible for them to be managed by different managers. In other words, it is possible to use the contribution site 13 having a different user layer from the service provision site 17, for submission, review, and so on of contents 11. Due to this, it is possible to embed the contribution site 13 that is specialized in the function of submission of contents and so on, for submission, utilization, and evaluation of contents 11. Accordingly, the user of the contribution site 13 can subsequently be guided toward utilization of the service provision site 17 and toward utilization of games, newly.

The present invention is not limited to the embodiment described above; it may be implemented in any appropriate manner. While, in the embodiment described above, the contribution site 13 and the service provision site 17 employed mutually different IDs as information for managing their respective users, these sites 13 and 17 are not limited to such an embodiment. Information such as the same ID on both these two sites, and the like may be utilized as information for specifying a user, and may be provided by a common management administrator.

Moreover, in the embodiment described above, in order to specify contents that have been subscribed to, as association data, there is employed the subscription data 16 which makes a direct association between the contents and the user IDs of the service provision site 17; but the association data is not limited to such an embodiment. For example, instead of the contents IDs, URLs may be described; and information for corresponding to a different table or the like for specifying the contents that have been subscribed to may be associated with the user IDs. In other words, provided that it is capable of linking to the contents that are the subject, it will be acceptable to employ any type of data as this association data, and it will also be acceptable to structure the linking units in any desired manner.

And while, in the embodiment described above, a business flow is employed in which contents to be utilized by an entertainment are determined and contracts are executed, after ranking results have appeared, the business flow is not limited to such an embodiment. For example, as the business flow, there may be employed business flows in which a condition for being utilized in the amusement is determined in advance, and contents that satisfy that condition are automatically utilized in the amusement, such as a business flow in which a predetermined number of contents of high ranking are used in a game. In this case it would also be possible to build the subscription page so that, by announcing details of a contract and items for attention and so on during the subscription process, and by arranging for the display of intention to subscribe also to correspond to consenting to those contract terms and so on, the contract is established in advance, using a subscription page. Since it is possible further to reduce the scope for human involvement by doing this, accordingly it is possible further to reduce development expenses and so on.

Moreover since, depending upon the contents, it may not be possible to utilize them just as they are in the amusement such as a game or the like, accordingly it would also be possible further to provide an editing unit in the amusement system 1 for performing editing so that contents that have been submitted are modified so as to be usable in the amusement. For example, as such an editing unit, it would be possible to provide a data generation system that generates sequence data in which the operation timings in a music game are recorded. Such a data generation system is a per se known technique for generating sequence data on the basis of audio data. For example, an editing unit such as a data generation system or the like may be provided upon the service provision site, and data that can be used by the amusement such as sequence data or the like may be supplied from contents submitted by users, using that site. In this case, it is possible to use contents that have been submitted, in the amusement in a simpler and easier manner.

While, in the embodiment described above, a game machine in an amusement facility was considered as one type of amusement machine, this type of embodiment is not to be considered as being limitative. Games of various types that are supplied by a game machine for household use may also be considered as amusements to which the present invention can be applied.

1. An amusement system, comprising:
a content storage unit that stores a content which is associated with an amusement supplied to a user, and is submitted via a network;
a contribution site provision server that provides a contribution site that receives, via the network, submission of the content and utilization of the content stored by the content storage unit; and
a service site provision server that provides a service provision site that provides a service associated with the amusement to a user, via the network, while managing association with information required for specifying the user;
wherein
a link unit that links to the contribution site so that the content is used, and a ranking information provision unit that provides ranking information for the content in accordance with a state of use on the contribution site, are provided in the service provision site.

2. The amusement system according to claim 1, wherein:
the contribution site is adapted and configured to provide receipt of at least one of the submission of the content and the utilization of the content while managing association with information required for specifying a user; and
the information for specifying the user of the contribution site and the information for specifying the user of the service provision site are managed as mutually different sets of information.

3. The amusement system according to claim 1, further comprising an association data storage unit that stores association data that is used for making association between the content and the user of the service provision site; and wherein
the link unit is adapted and configured to link to the content which is associated with the user of the service provision site by the association data.

4. The amusement system according to claim 3, wherein a relationship specification unit that is employed for specifying a correspondence relationship between the user of the service provision site and the content is provided to the service provision site.

5. The amusement system according to claim 1, wherein
a voting unit that receives votes for the content is provided to the service provision site, and
the number of votes via the voting unit is reflected in the ranking information.

6. The amusement system according to claim 5, wherein the voting unit is also provided to the contribution site.

7. The amusement system according to claim 6, wherein the voting unit is provided to the link unit.

8. The amusement system according to claim 5, wherein a voting history unit that provides information about the voting history with the voting unit to the user is provided to the service provision site.

9. The amusement system according to claim 1, wherein a link to the service provision site is provided in the contribution site.

10. The amusement system according to claim 1, further comprising an editing unit adapted and configured to perform editing so as to use at the amusement, the content to which a ranking has been assigned by the ranking information provision unit.

11. The amusement system according to claim 1, further comprising a gaming machine that provides a predetermined game as the amusement, and wherein
the content to which a ranking has been assigned by the ranking information provision unit are employed in the predetermined game.
